(19) United States
(12) Patent Application Publication
(10) Pub. No.: US 2002/0141750 A1
(43) Pub. Date: Oct. 3, 2002

(54) Photographic prints carrying meta data and methods therefor

(76) Inventors: Harold A. Ludtke, San Jose, CA (US); Eric Edwards, San Francisco, CA (US); Takako Miyazaki, New York, NY (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/823,046

(22) Filed: Mar. 30, 2001

(51) Int. Cl. G03B 17/24

(52) U.S. Cl. 396/312

(57) ABSTRACT

A photographic print includes a sheet, such as a sheet of photographic paper, having a front face and a back face, and one or more images printed on the front face of the sheet. The photographic print includes meta data in a human invisible format attached to the sheet of photographic paper, the meta data including information related to the photographic print. The meta data may be encoded digital data stored on magnetic material such as a sheet of magnetic material that is attached to the photographic print. The meta data may also be printed on substantially transparent optical material in a format that is invisible to the human eye. The meta data may also be a magnetic material or optical material that is mixed with the ink used to print the one or more images on the photographic print. The meta data attached to the photographic prints may be read using a meta data scanner capable of reading the meta data and displaying the meta data in a visual or audio format.

### FIELD OF THE INVENTION

The present invention is generally directed to the field of photography and is more particularly directed to photographic prints carrying meta data related to images appearing on the prints.

### BACKGROUND OF THE INVENTION

Every day, millions of people around the world take photographs of family, friends, pets and places of interest. These photographs are often treasured and placed in storage for viewing at a future date. Unfortunately, over time, individuals memories fade and these individuals are unable to remember the exact circumstances under which the photographs were taken.

In order to remember the circumstances surrounding a photograph, many individuals will write information directly onto a border of the photograph. For example, FIG. 1 shows a prior art photograph 20 including an image bearing portion 22 having an image 24 printed thereon and a border 26 surrounding the image bearing portion 22. The border 26 provides a limited space for attaching information 28 about the image 24 on the photograph 20. In some instances, additional information about the photograph may be written on the rear face (not shown) of the print 20. However, as will be described in more detail below, it would be desirable to provide a photographic print capable of carrying a substantial amount of information related to the image appearing on the print. Such information, commonly referred to as meta data, generally relates to the image, or when, where, how and by whom a photograph was taken (i.e., using a camera) or captured (i.e., scanned).

There have been many efforts directed to attaching information to photographic film. This information, such as photographing conditions, brightness levels, the type of film used, etc., is later used during the film developing process to enhance the quality of the photographic prints. For example, a camera may be provided with a recording apparatus for magnetically recording information on film, such as the exposure level of the film. The information recorded on the film is used when the film is developed and photographs are printed.

A photographic film strip may be provided with an additional magnetic layer including a plurality of magnetic tracks associated with each individual frame of the film. Each magnetic track is dedicated to the writing and reading of a predetermined set of parameters related to the corresponding photographic frame. The information recorded on the magnetic tracks can include for example, the film manufacturer, the camera user, the dealer and photo finisher, etc.

In spite of the above advances, there remains a need for improved devices and methods for attaching large amounts of information to photographic prints. One problem with current photographic media, such as paper based and plastic based media, is that the media do not have a convenient means for carrying large amounts of information about the image or the conditions under which the image was captured. As a result, when a person is looking at a picture taken many years earlier, the experience is diminished for lack of information as to the identity of the people or objects in the print, or where or when the picture was taken. Thus, there remains a need for a photographic print capable of carrying sufficient information or meta data regarding the identity of the people or objects in the print, or information about where, when, how and under what conditions the photograph was taken. Attaching such meta data to photographic prints will not only enhance the viewing experience, but will also allow the photographs to be easily reproduced.

### SUMMARY OF THE INVENTION

In accordance with certain preferred embodiments of the present invention, a photographic print includes a sheet of photographic paper or other image-bearing medium having a front face, a back face and at least one image printed on the front face of the photographic paper. The photographic print also preferably includes meta data in a human invisible format attached to the sheet of photographic paper, the meta data including information related to the images appearing on the photographic print, or the conditions (e.g. location, type of camera, type of film) under which the images were captured. Although the present invention is not limited by any particular theory of operation, as used herein the terminology “meta data” means any information that relates to the one or more images appearing on the photographic print, the persons or conditions under which the images were captured, the tools used to capture the images (i.e., a digital camera, scanner, etc.), or the persons or conditions under which the photographic print was processed. Preferred types of meta data that may be attached to photographic prints are set forth in more detail below.

In certain preferred embodiments, the meta data is digital information that is encoded onto a magnetic layer attached to photographic paper. The magnetic layer may include a plurality of substantially parallel magnetic tracks whereby each magnetic track is adapted to have encoded digital information stored therein. Such encoded digital information may be stored on the magnetic tracks by using a magnetic read/write device, such as the device disclosed in the above-mentioned '745 patent. In certain preferred embodiments, the magnetic layer is secured over the back face of the photographic paper. The sheet of magnetic material is substantially larger than the magnetic strip typically provided on bank cards. As a result, the volume of information that may be stored on the magnetic sheet is dramatically increased. In this embodiment, the digital information stored in the magnetic tracks may be read by placing the back surface of the photographic print against a magnetic reading device, further referred to herein as a meta data sensor. In other preferred embodiments, the photographic paper may include a top layer including the front face of the print, a bottom layer including the back face of the print, and a layer of magnetic material bearing meta data disposed between the top and bottom layers. In further embodiments, one or more images may be printed directly onto the layer of magnetic material, thereby avoiding the need for a paper-based material for receiving the ink.

In still other embodiments, the meta data is printed on a sheet of a substantially transparent optical material that bears the meta data in a range of the optical spectrum that is invisible to the human eye. For example, the meta data may be printed on the sheet of transparent optical material in a format that is visible in the ultraviolet range of the optical spectrum. In other preferred embodiments, the meta data may be printed on the sheet of optical material in a format that is visible in the infrared range of the optical spectrum.

The meta data may also be encoded in a digital data format and mixed with the ink used to print the one or more images on the front face of the photographic paper. In these embodiments, the ink is visible to the human eye for creating the one or more images, however, the attached meta data is invisible to the human eye. The one or more images may be divided into a plurality of pixels with at least some of the pixels having ink printed thereon for forming the one or more images. The meta data mixed with the ink and printed on the pixels may include magnetic material or optical material that is invisible to the human eye. In certain embodiments, two or more contiguous pixels may contain a single bit of the meta data. The meta data encoded in a magnetic material may preferably include a plurality of individual magnetic pulses whereby each individual magnetic pulse is secured to one or more of the pixels on a front face of the photographic paper. In still other embodiments, at least some of the pixels on the front face of the photographic paper may have one or more individual magnetic pulses secured thereto with ink printed atop the magnetic pulses.

In one particular preferred embodiment, the meta data is magnetic material that is mixed into an ink. The magnetic material may include an iron-based material or a material that is typically found in a magnetic strip of a bank or credit card. After the magnetic material is mixed into the ink, the ink may be printed onto a surface of a sheet of material to form one or more photographic images. The magnetic material in the ink may then be polarized to write information onto the print. The polarized magnetic material is preferably invisible to the human eye but may be read using one of the meta data sensors or readers described above.

In other embodiments, an optical material invisible to the human eye is mixed into the ink used to print one or more images on a surface. The ink carrying the optical material is then printed onto a surface, and the optical material is polarized to write information onto the print. The invisible optical material may be printed in rows or may be printed randomly throughout the surface of the print. In certain embodiments, the optical material is only encoded around some of the images appearing in the print. Thus, the print bears information about one or more significant objects appearing therein. A meta data sensor may then be used to “read” the meta data appearing on the print.

In still other preferred embodiments of the present invention, a method of making photographic prints having meta data attached to each print includes capturing a series of photographic images and recording information related to the images. Each of the captured images preferably has a unique portion of the recorded information associated therewith. The recorded information may relate to the subject of the photograph, or the time, place and location where the photograph was taken, or technical data related to the equipment or film used to capture the image. The method also preferably includes encoding the recorded information into meta data having a digital format and then storing each of the recorded photographic images and the digitally formatted meta data in a storage medium. One or more photographic prints may then be produced using the stored photographic images and digitally formatted meta data. Each photographic print preferably includes one of the photographic images and the portion of the digitally formatted meta data associated with the image. The digitally formatted information associated with each print is preferably attached to the print in a format that is invisible to a human eye. The meta data may be written on a sheet of magnetic material or a sheet of substantially transparent optical material, as will be described in more detail below.

In yet further preferred embodiments of the present invention, a method of making photographic prints having meta data attached thereto includes capturing one or more photographic images, recording information related to the one or more captured photographic images, whereby each captured image has a unique portion of the recorded information associated therewith, encoding the recorded information into meta data having a digital format, and storing the images and the meta data in a storage medium. The method may also include extracting the stored images and meta data from the storage medium and using the extracted images and meta data for producing one or more of the photographic prints having meta data attached thereto. The storage medium may include photographic film, digital film, a memory device, magnetic material, a compact disc, a digital video disc, or a camera having a memory device.

These and other preferred embodiments of the present invention will be described in more detail below.

### BRIEF DESCRIPTION OF THE DRAWINGS

FIG. 1 shows a front view of a prior art photograph including information about the image written on a border region of the photograph.

FIG. 2A shows a front view of a photograph having meta data attached thereto, in accordance with certain preferred embodiments of the present invention.

FIG. 2B shows a backside view of the photograph of FIG. 2A.

FIG. 2C shows a right side view of the photograph of FIG. 2A.

FIG. 3 shows a photograph having meta data attached thereto, in accordance with certain preferred embodiments of the present invention.

FIG. 4A shows a top view of a meta data scanner for reading the meta data attached to the photograph of FIGS. 2A-2C.

FIG. 4B shows a cross-sectional view of the meta data scanner of FIG. 4A taken along line IVB-IVB of FIG. 4A.

FIG. 5A shows a top view of the meta data scanner of FIGS. 4A and 4B after a photograph having meta data attached thereto has been secured atop the scanner.

FIG. 5B shows a cross-sectional view of the meta data scanner of FIG. 5A taken along line VB-VB.

FIG. 6 shows a schematic view of a camera used to write meta data on film, in accordance with certain preferred embodiments of the present invention.

FIG. 7 shows a schematic view of a read/write device for writing meta data onto magnetic strips of film.

FIG. 8 shows a block diagram illustrating a system for producing photographic prints having meta data attached thereto.

FIGS. 9A and 9B show respective front and right side views of a photographic print having meta data attached thereto, in accordance with further preferred embodiments of the present invention.

FIG. 10 shows a front view of a sheet having human invisible meta data printed on the sheet, in accordance with certain preferred embodiments of the present invention.

FIG. 11 shows a side view of a photographic print having meta data attached to the back surface of the print, in accordance with other preferred embodiments of the present invention.

FIGS. 12A and 12B show respective top and cross-sectional views of a meta data scanner for reading the optical meta data attached to the photographic print of FIG. 9A.

FIGS. 13A and 13B show respective top and cross-sectional views of the photographic print of FIG. 9A atop the meta data scanner of FIGS. 12A and 12B.

FIGS. 14A and 14B show a photographic print having human invisible optical meta data attached thereto, in accordance with further preferred embodiments of the present invention.

FIG. 15B shows a sheet of the human invisible optical meta data attachable to the front face of the photographic print of FIG. 14A.

FIGS. 16A and 16B show respective top and cross-sectional views of a meta data scanner for the photographic print of FIG. 14A in accordance with further preferred embodiments of the present invention.

FIGS. 17A and 17B show top and cross-sectional views of the meta data scanner of FIGS. 16A and 16B with the photographic print of FIG. 14A secured atop the scanner.

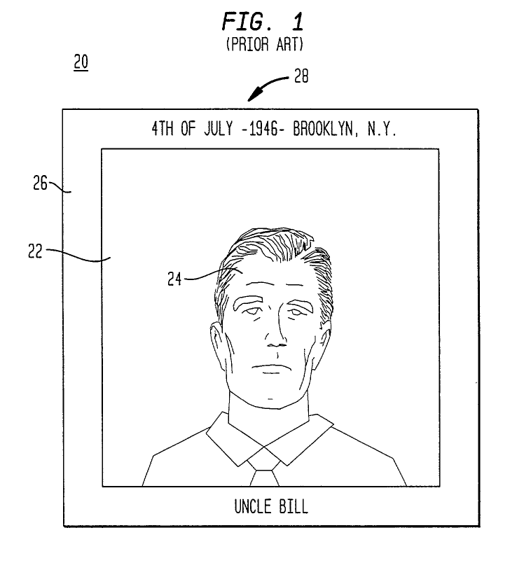

### DETAILED DESCRIPTION OF THE PREFERRED EMBODIMENTS

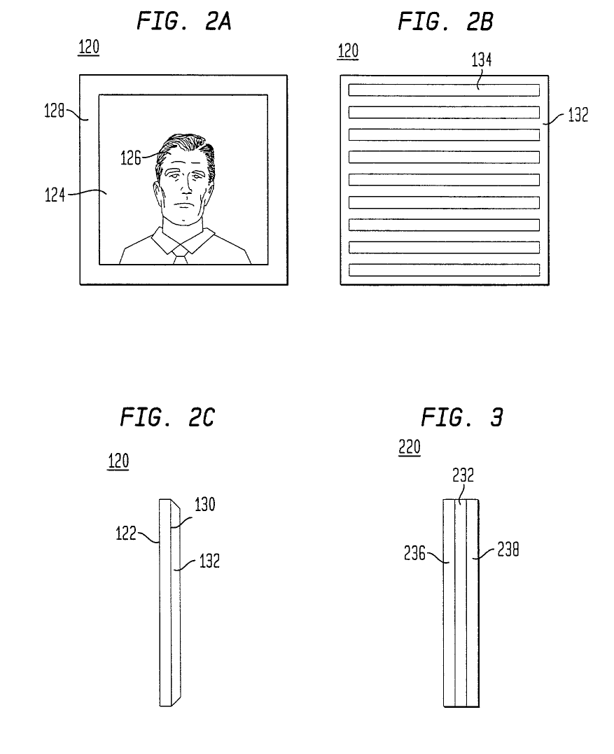

FIGS. 2A-2C show respective front, back and right side views of a photographic print carrying meta data, in accordance with certain preferred embodiments of the present invention. Photographic print 120 includes a front surface 122 having an image bearing region 124 with one or more images 126 printed in the image bearing region 124. Photographic print 120 may also include a border region 128 surrounding print bearing region 124. The border region 128 provides an area for handling photographic print 120 without adversely effecting the quality of the one or more images 126 printed thereon.

Referring to FIGS. 2B and 2C, photographic print 120 also preferably includes a rear surface 130 having a sheet of a magnetic material 132 attached thereto. The sheet of magnetic material 132 desirably has a plurality of substantially parallel tracks 134, each track 134 including information provided in a digital format. The digital information is preferably meta data that may be read by a magnetic read/write device capable of reading the digital data encoded on the magnetic sheet 132. Such digital information may then be transformed into a format presentable to a viewer of the photographs such as a video or audio format. As used herein, the terminology “meta data” means information that relates to images appearing on photographic prints, the conditions under which the images were captured, or conditions under which the images were processed for making photographic prints. Common types of meta data include but are not limited to:

Information about the people or objects appearing in the photographic prints.

Descriptive information about the contents of the photographic prints including names, locations, objects, environmental conditions such as global positioning satellite (GPS) location and camera orientation, date and time that the photographs were taken, etc.

Three dimensional (3-D) graphic models for enhancing the image when the photographic prints are viewed on a digital device such as a television or personal computer screen.

The characteristics of the camera, paper, ink and processes used to capture the images and produce the photographic prints so that an exact duplicate copy may be produced at a later time.

One or more Internet URL's that refer to web pages for, (a) the photographer, (b) the people or subjects of the photographs, (c) a service processing bureau that can offer duplicates or other services related to the prints, (d) the camera or the manufacturer of the camera used to take the photographs, (e) an on-line photograph album with one or more images that form some kind of related collection, such as a family history, yearbook, etc.

1. Voice annotation.

2. Audio information recorded at the time the photographs were captured or added at a later date for providing additional information to a viewer.

3. Different messages specially directed to the needs of the viewer.

4. Medical information for medical images.

5. Encoding the original image data so that the image may be easily reproduced.

6. Other sensory data not limited to sight or sound that will enhance the viewing experience.

The meta data may be stored on the magnetic material sheet 132 in many different formats. In one preferred embodiment, a graphics format such as JPEG may be used to encode the meta data. However, the particular choice for the graphics format may depend upon the equipment used by the recipient of the photographic prints. For example, a service that provides photographic prints for viewing on a Macintosh platform may encode the images in a MacOS native graphics format such as QuickDraw or QuickDraw 3D. Most of the non-graphical data attached to the magnetic sheet 132 would preferably be encoded in a format such as ASCII or Unicode, or in analog or digital audio data.

FIG. 3 shows a photographic print 220 in accordance with another preferred embodiment of the present invention including a front sheet 236, a rear sheet 238 and a sheet of a magnetic material 132 disposed between front and back sheets 236, 238. In this particular embodiment, front sheet 236 includes a photographic image printed thereon. Magnetic material sheet 232 is substantially similar to the magnetic material sheet 132 shown in FIG. 2B. The embedded magnetic material sheet 232 has meta data encoded therein, the meta data preferably relating to the image printed on front sheet 236 or the conditions under which the photograph was taken.

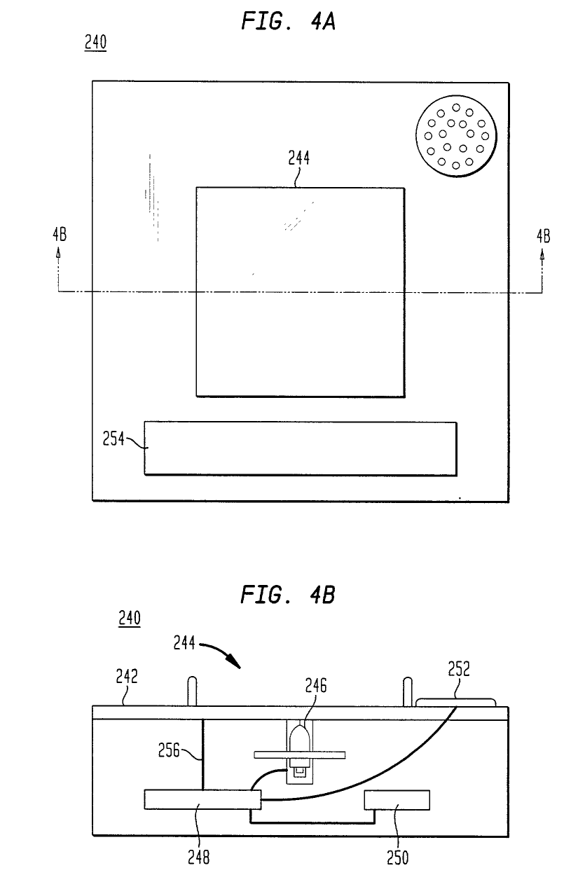

FIGS. 4A and 4B show a meta data scanner used to read the meta data information attached to photographic print 120 of FIG. 2A. As used herein, the terminology “meta data scanner” means any electronic, magnetic or opto-electronic device that may be used to read information attached to a photographic print, whereby the information may be stored in a digital, magnetic or optical format. Meta data scanner 240 includes a top surface 242 having a receiving area 244 that is adapted to receive a photographic print having meta data attached thereto. Meta data scanner 240 includes a magnetic read/write device 246 capable of reading the digital data encoded in the magnetic material sheet 132 attached to the back face 130 of photographic print 120. The magnetic read/write device 246 is attached to a controller 248, such as a microprocessor-based controller, that controls overall operation of the scanner 240. The meta data scanner 240 includes a memory device 250 for storing one or more operational routines and/or data about photographic images or meta data attached to the photographic images. Meta data scanner 240 also preferably includes a speaker 252 for broadcasting audio or sound, as will be described in more detail below. Scanner 240 also preferably includes a visual display area 254 such as a liquid crystal display (LCD) or LED display. The visual display area 254 is in signal receiving relationship with controller 248 via communication line 256.

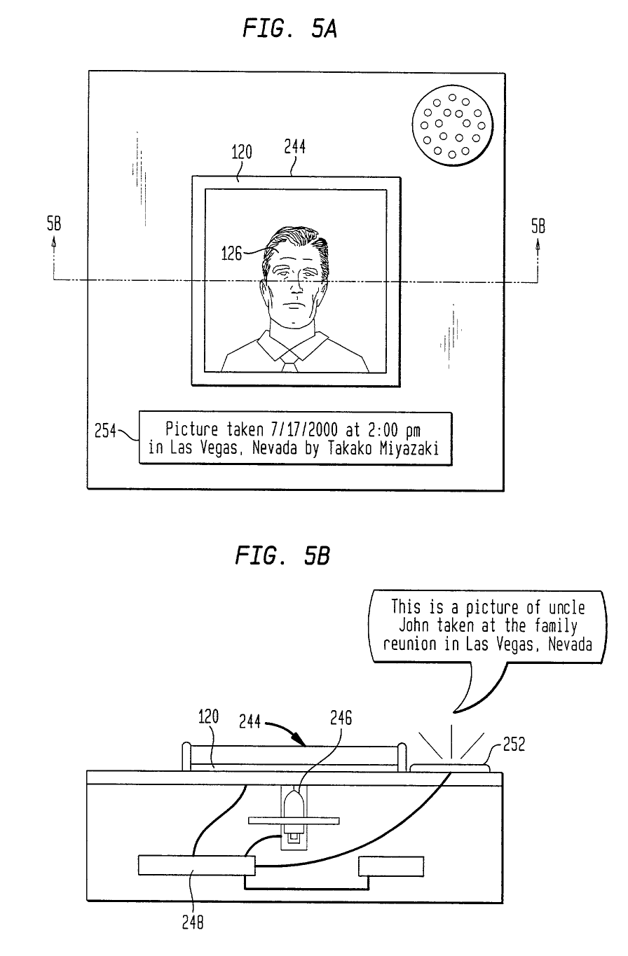

Referring to FIGS. 5A and 5B, in operation, photographic print 120 is placed in the photographic print receiving area 244 so that magnetic read/write device 246 may begin to read the meta data encoded in the magnetic material sheet (FIG. 2B). The digital information is transmitted from read/write device 246 to controller 248. Controller 248 then preferably runs one or more subroutines to decode the digital data. The decoded digital data may then be shown in visual display 254 and/or broadcast as sound through speaker 252. In the particular embodiment shown in FIGS. 5A and 5B, the meta data scanner 240 displays visual information related to the photo in visual display 254 while broadcasting audio through speaker 252. The content of the information presented in visual display 254 may differ from that broadcast through speaker 252. For example, the information shown in visual display 254 may relate to information about when, where and by whom the photograph was taken. In contrast, the information broadcast via speaker 252 may relate to the image 126 shown in the photographic print 120.

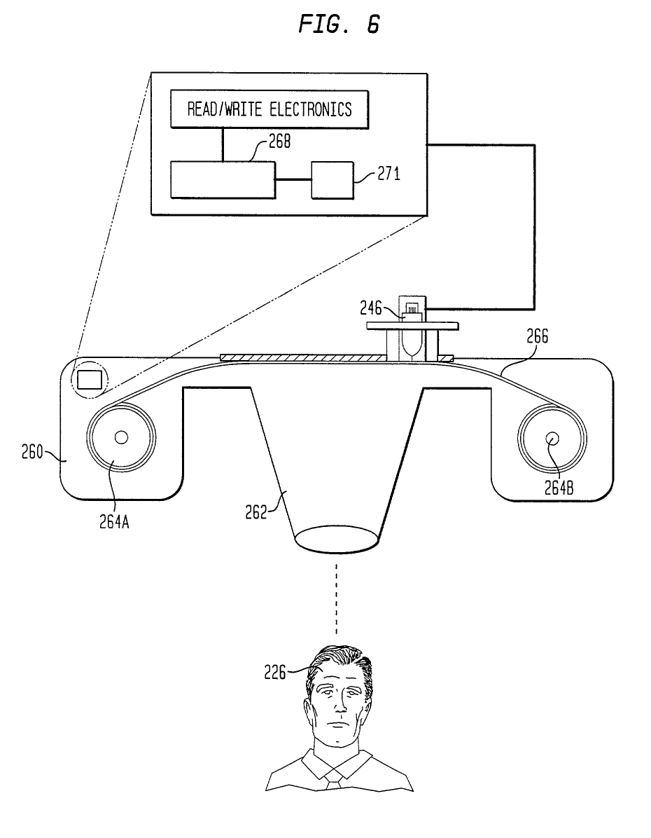

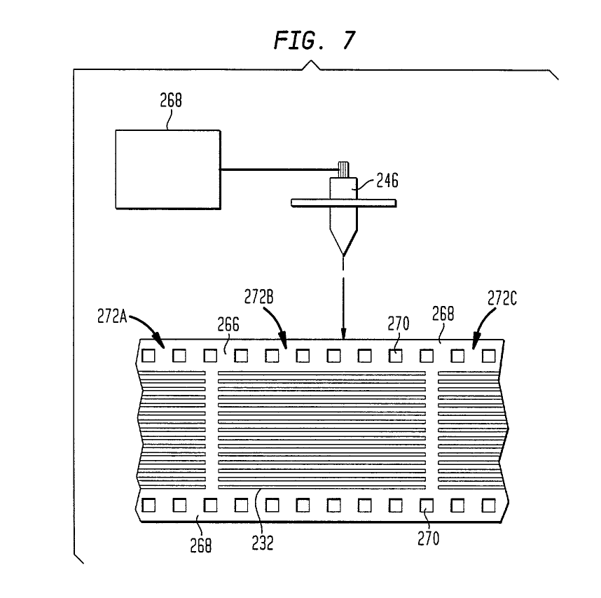

FIGS. 6 and 7 show one method of capturing an image on film and also writing meta data related to the capturing of the image on film. Camera 260 includes lens 262 and spools 264A, 264B carrying film 266. Film 266 includes borders 268 having sprockets 270 for advancing successive frames of film 266 through camera 260. In a particular embodiment shown in FIG. 7, film 266 includes photographic frames 272A, 272B and 272C, each photographic frame 272 being adapted to be exposed to an image transmitted through camera lens 262. Each frame 272 has a unique sheet of magnetic material 232 associated therewith, the magnetic sheet including a plurality of substantially parallel magnetic tracks 232 adapted to store encoded digital data thereon.

As camera 260 is operated to capture image 226 through lens 262, read/write device 246 records meta data on the parallel magnetic tracks 232 associated with the particular frame 272 of film 266. Controller 269 operates Read/write device 246. Camera 260 also preferably includes a memory 271 for storing operational subroutines and/or meta data in a digital format that is related to the photographs taken using camera 260.

FIG. 8 shows one preferred method for producing photographic prints having meta data attached thereto. In a first step 282, one or more images are captured using devices such as a digital camera, film camera scanner, video camera or stock photos. The captured image is then attached to a medium such as photographic film. At approximately the same time, meta data related to the image is compiled and attached to a second medium, such as a magnetic sheet, at step designated by reference numeral 284. A controller 286 including a memory device 288 is desirably used to capture image data and meta data and attach such image data and meta data to media. The image data and meta data may also be stored in a memory device. At step 290, the image and meta data are attached to another medium, such as photographic paper. The image data may be printed on a first face of the photographic paper while the meta data may be encoded onto a magnetic sheet (step 29) attachable to a back face of the photographic paper.

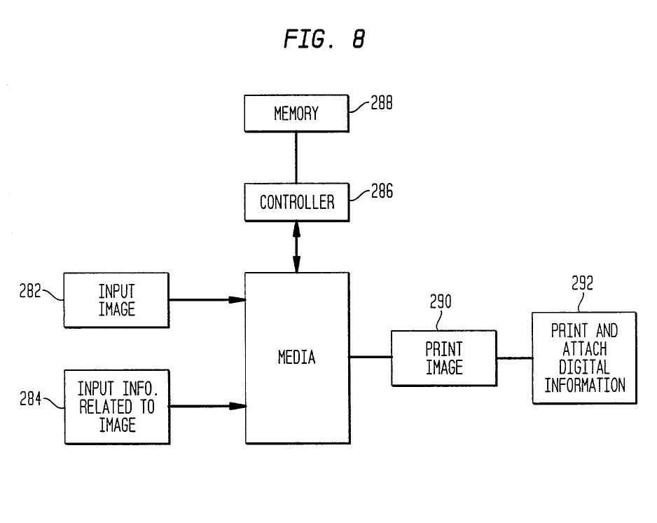

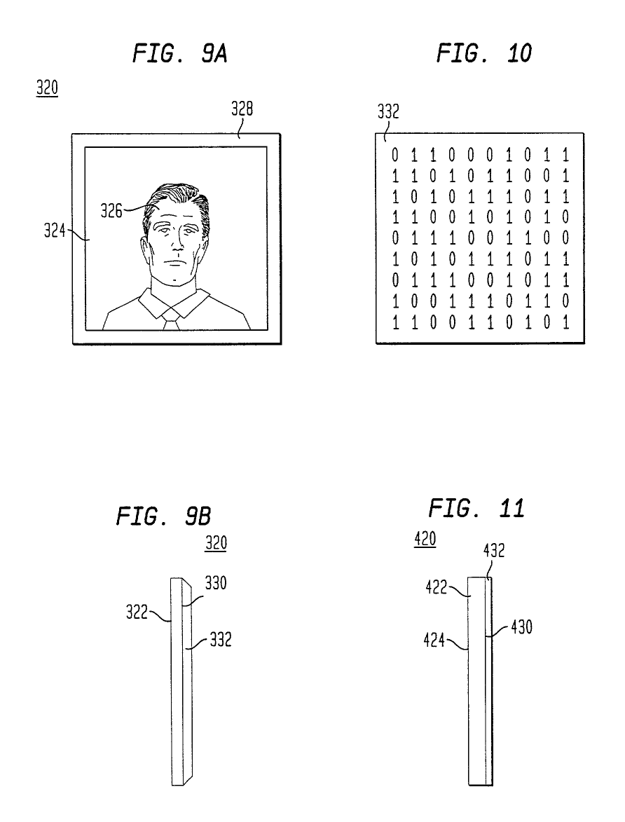

FIGS. 9A, 9B and 10 show a photographic print having meta data in the form of a substantially transparent sheet of optical material secured over the front face thereof. Photographic print 320 includes front face 322 having an image bearing region 324 for receiving one or more images 326 and a border region 328 surrounding the image bearing region 324. Photographic print 320 also includes a rear surface 330 remote from front surface 322. Referring to FIGS. 9B and 10, a substantially transparent sheet 332 of an optical material is preferably secured over the front surface 322 of photographic print 320. In preferred embodiments, the sheet of optical material 332 preferably has information encoded therein in a digital format. The information is preferably meta data related to the production of the photographic print 320 and/or the images or objects printed in the image receiving area 324 of photographic print 320. As shown in FIG. 10, the digital information is encoded into zeroes (0) and ones (1) provided in a series of substantially parallel rows. The digital information is printed in a format that is invisible to the human eye. In certain preferred embodiments, the digital information is printed so that it can only be seen in the ultraviolet or infrared ranges of the optical spectrum. Thus, the meta data provided on the substantially transparent sheet of optical material 332 will not block the images on the photographic print and may only be retrieved using a device capable of “viewing” the information in the ultraviolet and/or infrared ranges, or other ranges of the spectrum that are not visible to the human eye.

FIG. 11 shows a photographic print 420 in accordance with other further embodiments of the present invention including a front face 422 having one or more images printed in an image receiving area 424 thereof and a rear face 430 remote from front face 422. A substantially transparent sheet of optical material 432 is secured over rear face 430 of photographic print 420. Optical sheet 432 has encoded therein meta data in a digital format, the meta data being invisible to the human eye.

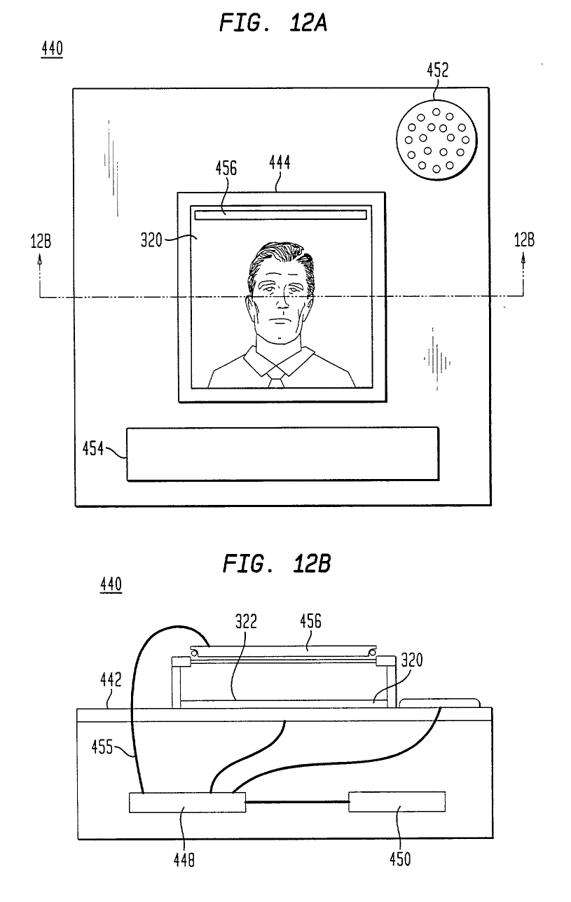

FIGS. 12A and 12B show a meta data scanner 440 used to read the meta data secured to the photographic print 320 shown and described above in FIG. 9A. Meta data scanner 440 includes a top surface 442 having a photographic print receiving area 444 adapted to receive photographic print 320. Meta data scanner also includes a visual display 454 such as a liquid crystal display and a speaker 452 for broadcasting sound.

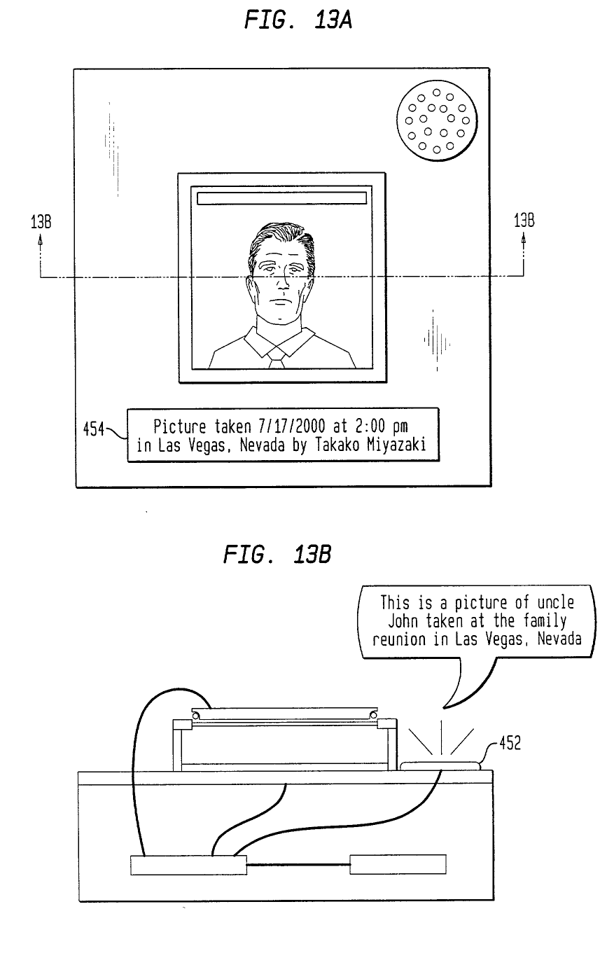

Referring to FIG. 12B, meta data scanner 440 includes scanning element 456 that is capable of scanning the human invisible digital data secured atop the front face of photographic print 320. In certain preferred embodiments, scanning element 456 passes over the entire front surface 322 of photographic print 320. The scanned information is then transmitted to controller 448 via communication line 455. Controller 448 may operate one or more scanning and reading subroutines stored in memory 450. Referring to FIGS. 13A and 13B, after the human invisible digital data has been scanned, controller 448 processes the digital data to produce a visual message shown in visual display 454. At approximately the same time, some of the digital information may be transformed into sound and broadcast from speaker 452. The information presented in visual display 454 may differ from that broadcast through speaker 452. As mentioned above, in certain preferred embodiments, the digital information printed on the transparent optical sheet 332 is printed in a range of the optical spectrum that is invisible to the human eye. For example, the digital information may be printed in the ultraviolet or infrared ranges. Thus, the human invisible digital data cannot be seen by a human eye, but may be picked up by specially designed optical devices. As a result, the digital data may be secured directly over the image bearing surface on the front face of a photographic print while still allowing a viewer to clearly see the photograph.

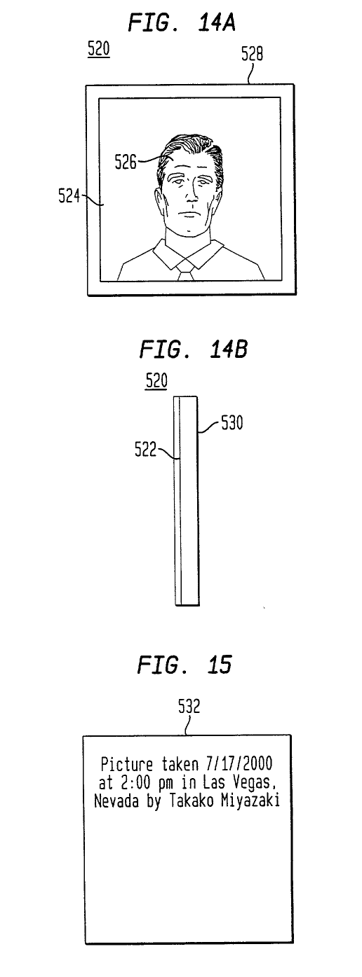

FIGS. 14A, 14B and 15 show a photographic print having meta data secured thereto, in accordance with still further preferred embodiments of the present invention. Referring to FIGS. 14A and 14B, photographic print 520 includes front surface 522 having an image bearing region 524 with one or more images 526 printed thereon. Photographic print 520 may also include a border region 528 that facilitates handling of the print. Photographic print 520 also preferably includes rear surface 530 remote from front face 522. Referring to FIGS. 14B and 15, a transparent optical sheet 532 carrying meta data invisible to the human eye is secured over the image 526 on the front face 522 of photographic print 520. As shown in FIG. 15, the human invisible meta data is in the form of readable text that is printed in a range of the optical spectrum that is invisible to the human eye. As a result, the substantially transparent optical sheet 532 may be secured directly over the front surface 522 of photographic print 520 while still allowing the image 526 to be seen clearly through the optical 532.

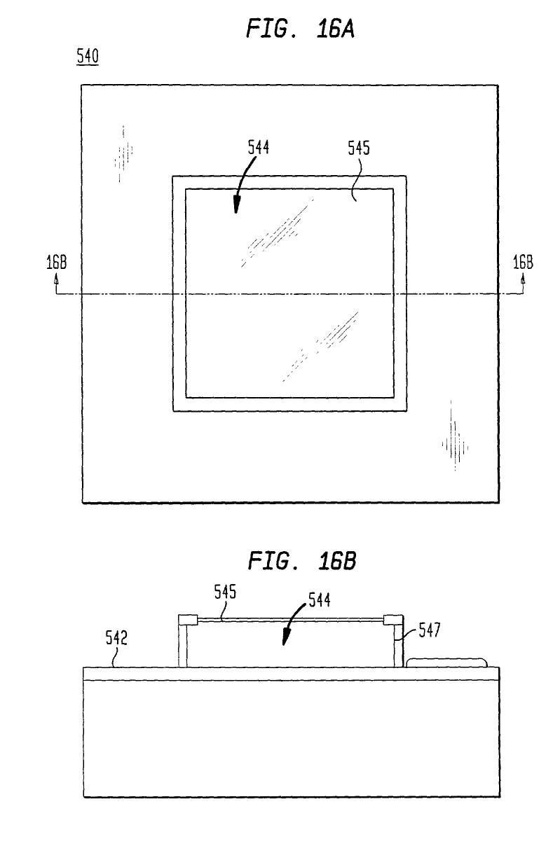

Referring to FIGS. 16A and 16B, the human invisible text appearing on the front surface of photographic print 520 may be viewed using a specially designed meta data scanner 540 having a top surface 542 with a photographic print receiving area 544. A specially designed optical viewing lens 545 is secured over the photographic print receiving area 544 by support frame 547. The viewing lens is adapted to transform the human invisible text on the optical sheet 532 into text that is visible to the human eye.

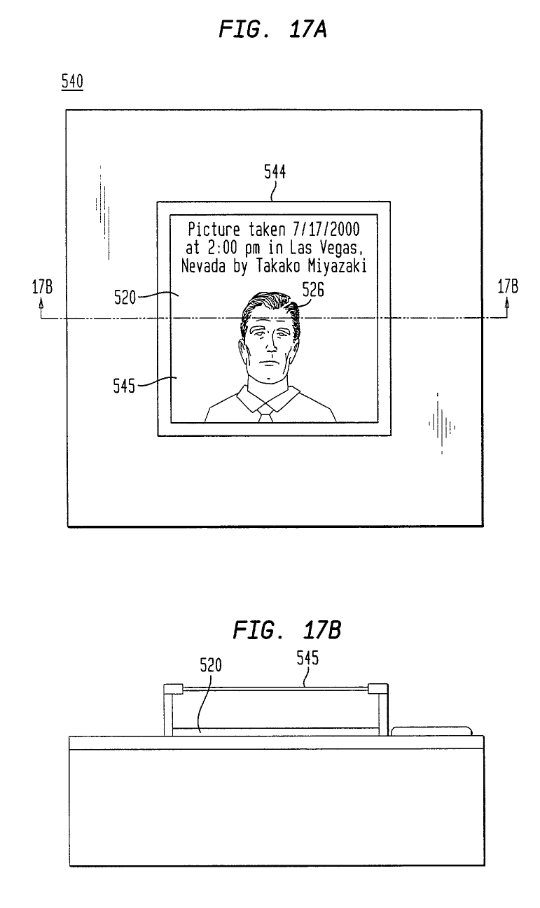

FIGS. 17A and 17B show the photographic print 520 of FIG. 14A secured within the photographic print receiving area 544 of meta data scanner 540. Lens 545 transforms the human invisible text into a format that is visible to the human eye. As a result, the image 526 appearing on photographic print 520 as well as the text printed on optical sheet 532 may be viewed through lens 545.

While the present invention has been described in detail by specific references to certain preferred embodiments thereof, it is understood that other variations and modifications may be made to the present invention without departing from the spirit and scope of the present invention.

What is claimed is:

1. A photographic print comprising:
a sheet having a front face and a back face;
one or more images printed on the front face of said sheet; and
meta data in a human invisible format attached to said sheet, wherein said meta data includes information related to at least one of the one or more images printed on said sheet.

2. The photographic print of claim 1, wherein said meta data is digitally encoded information attached to said sheet.

3. The photographic print as claimed in claim 1, wherein said sheet is a sheet of photographic paper.

4. The photographic print as claimed in claim 1, wherein said sheet is a magnetic sheet.

5. The photographic print as claimed in claim 1, wherein said meta data is digital data encoded in magnetic material attached to said sheet.

6. The photographic print as claimed in claim 5, wherein said magnetic material includes a plurality of substantially parallel magnetic tracks, each said magnetic track being adapted to have information in a digital format stored therein.

7. The photographic print as claimed in claim 3, wherein said meta data is digital data encoded in a magnetic material attached to said sheet of photographic paper.

8. The photographic print as claimed in claim 7, wherein said magnetic material is secured over the back face of said sheet of photographic paper.

9. The photographic print as claimed in claim 8, wherein said sheet of magnetic material covers substantially the entire back face of said photographic paper.

10. The photographic print as claimed in claim 5, wherein said photographic paper comprises a top layer including said front face, a bottom layer including said back face, and wherein said magnetic material is disposed between said top and bottom layers.

11. The photographic print as claimed in claim 1, wherein said meta data is printed on optical material in a range of the optical spectrum that is invisible to the human eye.

12. The photographic print as claimed in claim 1, wherein said meta data is visible in the ultraviolet range of the optical spectrum.

13. The photographic print as claimed in claim 1, wherein said meta data is visible in the infrared range of the optical spectrum.

14. The photographic print as claimed in claim 11, wherein said optical material is substantially transparent.

15. The photographic print as claimed in claim 11, wherein said optical material is attached to the front face of said sheet.

16. The photographic print as claimed in claim 11, wherein said optical material is attached to the back face of said sheet.

17. The photographic print as claimed in claim 11, wherein said meta data is printed on a sheet of said optical material attached to said sheet of photographic paper.

18. The photographic print as claimed in claim 17, wherein said sheet of said optical material substantially covers the entire front face or back face of said print.

19. The photographic print as claimed in claim 1, wherein the front face of said sheet is divided into a plurality of pixels, at least some of said pixels having ink printed thereon for forming said image.

20. The photographic print as claimed in claim 19, wherein the ink printed on said pixels has one or more bits of said meta data mixed therein.

21. The photographic print as claimed in claim 20, wherein the ink printed on said pixels has magnetic material mixed therein.

22. The photographic print as claimed in claim 21, wherein the magnetic material is invisible to the human eye.

23. The photographic print as claimed in claim 20, wherein the ink printed on said pixels includes optical material mixed therein that is invisible to the human eye.

24. The photographic print as claimed in claim 19, wherein two or more contiguous pixels of said image contain a single bit of said meta data.

25. The photographic print as claimed in claim 1, wherein said meta data is mixed with an ink that is applied to the front face of said sheet to form said one or more images.

26. The photographic print as claimed in claim 25, wherein said meta data is encoded in a magnetic material comprising a plurality of individual magnetic pulses.

27. The photographic print as claimed in claim 26, wherein the front face of said photographic paper is divided into a plurality of pixels, each said individual magnetic pulse being secured to one or more of said pixels.

28. The photographic print as claimed in claim 27, wherein at least some of said pixels have at least one of said individual magnetic pulses and have ink printed thereon.

29. A photographic print including:
an image bearing medium having a front face and a back face;
at least one image printed on the front face of said medium;
magnetic material attached to the back face of said medium, said magnetic material having meta data stored therein in a format invisible to the human eye.

30. The photographic print as claimed in claim 29, wherein said meta data is decodable for providing information about said photographic print.

31. The photographic print as claimed in claim 29, wherein said image bearing medium is photographic paper.

32. The photographic print as claimed in claim 29, wherein said image bearing medium is a sheet of magnetic material.

33. The photographic print as claimed in claim 29, wherein said magnetic material is a sheet of magnetic material that covers substantially the entire back face of said image bearing medium and includes a plurality of substantially parallel magnetic tracks, each said magnetic track being adapted to have a portion of said meta data stored therein.

34. A photographic print comprising:
an image bearing medium having a front face and a back face;
at least one image printed on the front face of said medium;
substantially transparent optical material attached to said image bearing medium, said optical material being invisible to the human eye.

35. The photographic print as claimed in claim 34, wherein the meta data printed on said optical material is encoded as digital data.

36. The photographic print as claimed in claim 34, wherein the meta data printed on said optical material is in a plain text format.

37. The photographic print as claimed in claim 34, wherein said meta data printed on said optical material is visible in the ultraviolet or infrared ranges of the optical spectrum.

38. The photographic print as claimed in claim 34, wherein said optical material is a sheet of optical material that substantially covers the entire front face or back face of said image bearing medium.

39. A method of making photographic prints having meta data attached thereto comprising:
capturing one or more photographic images;
recording information related to the one or more captured photographic images, wherein each said captured image has a unique portion of the recorded information associated therewith;
encoding said recorded information into meta data;
producing at least one photographic print, each said print including at least one of said photographic images and the portion of the meta data associated therewith, wherein the portion of the meta data associated with each said print is attached to said print in a format invisible to a human eye.

40. The method as claimed in claim 39, further comprising storing each said photographic image and the meta data associated therewith in a storage medium.

41. The method as claimed in claim 40, wherein said meta data is stored in a digital format.

42. The method as claimed in claim 40, wherein the storing step includes:
providing a storage medium including photographic film having a series of frames, each said frame including a unique sheet of a magnetic material associated therewith;
exposing one of the frames to an image;
writing information related to the image on the sheet of a magnetic material associated with said image.

43. The method as claimed in claim 39, wherein the recording step comprises:
providing a digital camera having a memory device;
capturing one or more images in a digital format, each said image including a plurality of pixels;
storing information related to the one or more images in a memory device.

44. A method of making photographic prints having meta data attached thereto comprising:
capturing one or more photographic images;
recording information related to the one or more captured photographic images, wherein each said captured image has a unique portion of the recorded information associated therewith;
encoding said recorded information into meta data; and
storing said images and said meta data in a storage medium.

45. The method as claimed in claim 44, further comprising extracting said stored images and meta data from said storage medium and using the extracted images and meta data for producing one or more of the photographic prints having meta data attached thereto.

46. The method as claimed in claim 44, wherein said storage medium is selected from the group consisting of photographic film, digital film, a memory device, magnetic material, a compact disc, a digital video disc, and a camera having a memory device.
